(19) United States
(12) Patent Application Publication
(10) Pub. No.: US 2008/0031805 A1
(43) Pub. Date: Feb. 7, 2008

(54) Method For The Production Of Chlorine Dioxide

(75) Inventors: Ralph Bergmann, Weinheim (DE); Jurgen Johann, Mondsee (AT)

Correspondence Address: WILLIAM COLLARD;COLLARD & ROE, P.C., 1077 NORTHERN BOULEVARD, ROSLYN, NY, 11576, US

(73) Assignee: WP ENGINEERING LIMITED, Valletta (MT)

(21) Appl. No.: 11/587,277

(22) PCT Filed: Apr. 22, 2005
(86) PCT No.: PCT/EP05/04315

§ 371 Date: Dec. 15, 2006

(30) Foreign Application Priority Data
Apr. 22, 2004 (DE) 10 2004 020 815.8

(51) Int. Cl. C01B 11/02

(52) U.S. Cl. 423/477

(57) ABSTRACT

Disclosed are a method and a preparation for producing chlorine dioxide for disinfection purposes using a two-component system in an aqueous solution. According to the invention, the two-component system is formed by a chlorite component and a salt component. The chlorite component is composed of an alkaline earth chlorite or alkaline chlorite while the salt component is composed of an alkaline halide or alkaline earth metal halide or sulfate or nitrate and does not have an acid, oxidative, or catalytic effect on the chlorite in an aqueous solution.

The invention relates to a method for the production of chlorine dioxide for disinfection purposes, in which a two-component system in aqueous solution is used. The invention furthermore relates to a preparation for such a method.

The liquid/solid and liquid/liquid two-component systems that are available on the market for the production of chlorine dioxide on site work with an acid (particularly hydrochloric acid) and sodium chlorite, or with an oxidant (e.g. a peroxodisulfate) and sodium chlorite, if necessary also with an immobilized catalyst, e.g. platinum oxide. After the two components are mixed, a solution that contains chlorine dioxide is formed. However, handling of hydrochloric acid is problematic, because of its tendency to gas out. The kinetics of chlorine dioxide formation are accelerated by means of the use of salts having an oxidative and/or acidic effect, in such a manner that almost complete conversion occurs within a short period of time. As a consequence, the starting substances always have to be stored separately. After the formation reaction has been completed, however, the speed of the decomposition process also increases.

The mixed solutions therefore have only a limited shelf life. Another disadvantage of the high reaction efficiency lies in the fact that the work always has to be carried out in dilution, in order to preclude the risk posed by chlorine dioxide that has formed. Solutions from approximately 8 g/l chlorine dioxide with a gas cushion above them can explode.

All of the processes mentioned are based on the oxidation of the chlorite anion to form chlorine dioxide. The oxidation is accelerated either by means of strong oxidants (electrolytic current, peroxodisulfate, or chlorine), or by means of the addition of acid or the use of an immobilized catalyst. If a third component as a stabilizing agent is not used, the starting substances are packaged in different containers, in order to prevent premature reaction, or an inert separation layer is introduced between the two reaction partners.

While the aforementioned methods are part of the aspect of maximized chemical conversion and therefore process economy, this is of secondary importance when using chlorine dioxide to disinfect ion exchangers or also in foods and cosmetics. Here, the important thing is to adhere to the appropriate chemicals laws.

Sodium chloride or potassium chloride, in some cases also magnesium chloride, are used in the regeneration of ion exchangers, which serve to soften water, among other things. During the softening process, calcium ions and magnesium ions are exchanged for sodium ions or potassium ions, in part only calcium ions are exchanged for magnesium ions. A problem of ion exchangers is their tendency to become germ-laden. Various disinfection methods exist for preventing germ buildup, but these must be carried out as a separate step in the operation of the ion exchanger.

Proceeding from this, the invention is based on the task of avoiding the disadvantages that occur in the state of the art, and of achieving a disinfectant effect, particularly in water treatment equipment, directly at the location of use, with a system that is easy to handle.

To accomplish this task, the combination of characteristics indicated in claim 1 and claim 11, respectively, is proposed. Advantageous embodiments and further developments of the invention are evident from the dependent claims.

The invention proceeds from the idea of making chlorine dioxide available as a biocidal substance directly at the location of use, without the starting substances possessing an elevated hazard potential. Accordingly, it is proposed, in terms of the method, that the two-component system is formed from a chlorite component and a salt component, whereby the chlorite component contains an earth alkali chlorite and/or alkali chlorite, and whereby the salt component contains an alkali metal halogenide or earth alkali metal halogenide, or a sulfate or nitrate of alkali metal or earth alkali metal, or a mixture thereof, as the main component (main component in the sense of a proportion of at least 98 wt.-%), and does not have an acidic nor an oxidative nor a catalytic effect with regard to conversion of the chlorite, in aqueous solution.

The advantage of this two-component system consists in its good handling ability and simplicity as well as with regard to the reduced hazard of the chemicals used (no chemicals that can lead to chemical burns as solutions), and also their availability and acquisition costs. Surprisingly, it was found that the oxidation of the chlorite anion proceeds advantageously even without additional oxidants or acids or catalysts, within the framework described for the above applications. The kinetics of chlorine dioxide formation are advantageously decelerated by means of the use of salts that have no oxidative or acidic or catalytic effect with regard to the oxidation of the chlorite, so that almost 100% conversion does not occur within the shortest possible period of time.

It is advantageous if the chlorite component and the salt component are dissolved in water, particularly as a homogeneous binary solid mixture or as a shaped product. This offers the possibility of making a combined disinfection and regeneration salt available. The chlorine dioxide does not form until dissolving in water takes place.

An alternative solution provides that the chlorite component is added to the solid salt component as a prefinished aqueous solution. The chlorine dioxide forms as a result of the moisture that is already contained, in part, in the starting salts, and the water component of the chlorite solution.

Finally, to the extent that the work is to be carried out with solutions, a solution of the chlorite component and a solution of the salt component can be mixed.

It is particularly advantageous if a salt component is used that reacts essentially in neutral or alkaline manner in aqueous solution. Preferably, the salt component consists of sodium chloride.

The salt component can additionally contain secondary components such as production aids or contaminants, with a proportion of max. 2 wt.-%. An advantageous embodiment provides that a technical regeneration salt for ion exchangers, for example according to the EN 973 standard, is used as the salt component. This offers the possibility of producing a regeneration salt that contains a biocidal component. In this way, complicated disinfection steps and apparatus for carrying out disinfection are eliminated in the use of the regeneration salt, for example in ion exchangers for water softening.

It is advantageous if the chlorite component consists of sodium chlorite. At a total content of sodium chlorite of less than 3 wt.-% with reference to the total system, a sodium chloride/sodium chlorite preparation also does not have to be labeled in the sense of the chemicals law (EU Guideline 1999/45 EU), and this clearly increases acceptance.

The invention also comprises a preparation for producing chlorine dioxide in aqueous solution for disinfection purposes, containing an earth alkali chlorite or alkali chlorite as the chlorite component and an alkali metal halogenide or earth alkali metal halogenide, or a sulfate or nitrate of alkali metal or earth alkali metal, or a mixture thereof, as the salt component of a two-component system, whereby the salt component has no acidic or oxidative or catalytic effect with regard to the chlorite, in aqueous solution.

A preferred possibility of use of the invention consists in ion exchangers, particularly in water treatment or in household appliances, particularly dishwashers.

The invention also offers the possibility of developing formulations of foods or cosmetics, in targeted manner, in which the chlorine dioxide that is formed counteracts germ buildup.

In the following, the invention will be explained in greater detail using exemplary embodiments.

Four homogeneous two-component mixtures were produced, consisting, in each instance, of 26 g salt component (sodium chloride, (quality p.a.), potassium chloride (quality p.a.), magnesium sulfate heptahydrate (quality p.a.), regeneration salt according to EN 973) and 0.75 g sodium chlorite (quality techn.), in each instance, as the chlorite component. The mixture with magnesium sulfate heptahydrate serves as the comparison.

In each instance, 75 ml fully desalinated water were added to the four homogeneous two-component solid substance mixtures. The pH of the liquid phase was determined after 15 minutes, and the concentration of chlorine dioxide was determined after a reaction time of 120 minutes. The results were as follows:

| | | |
|---|---|---|
| Sodium chloride, p.a. | pH = 9.58 | 1.38 mg/l ClO₂ |
| Potassium chloride, p.a. | pH = 10.35 | 30.5 mg/l ClO₂ |
| Magnesium sulfate, p.a. | pH = 8.50 | 1.86 mg/l ClO₂ |
| Sodium chloride (reg. salt) | pH = 9.40 | 39.2 mg/l ClO₂ |

To prepare a binary homogeneous solid substance mixture, a trituration was produced from 0.01% to 3% technical sodium chlorite and 99.9% to 97% regeneration salt for ion exchangers (NaCl).

Subsequently, as much water was added to the trituration so that a base body of solid substance remained and a saturated salt brine formed. Chlorine dioxide began to form within a period of at least 15 minutes. The formation of chlorine dioxide could be recognized by the fact that the solution, which was colorless at first, began to turn yellow-green. When the content of sodium chlorite was increased, the yield of chlorine dioxide also increased.

The amount of chlorine dioxide that was formed was already greater by a factor of 4 than the chlorine dioxide that was formed from the solution consisting of technical sodium chlorite after only 15 minutes. The formation of chlorine dioxide came to a stop after some time (several hours), as a function of the ambient conditions.

For simplified metering, a tablet of a homogeneous mixture of 20 g ground dishwasher regeneration salt (Henkel, Somat) and 0.2 g NaClO₂, technical (Riedel de Haen) was pressed at 500 bar pressing pressure. Dissolving this tablet in 800 ml water from the public water supply yielded 28 mg/l ClO₂.

The theoretical conversion calculation yields the following values:

Technical product contains only 80% NaClO₂, in other words 0.16 g, in the present case, corresponding to 1.78 mmol. From this, in accordance with the following hypothetical reaction
5 ClO₂⁻+2 H₂O→Cl⁻+4 ClO₂+4 OH⁻

1.78*4/5 mmol ClO₂ can be formed. This corresponds to 95.3 mg (molar mass ClO₂: 67 g). This results in a yield of approximately 24%

The reaction speed and the position of the equilibrium of the chlorine dioxide formation are greatly dependent on pH. In acid solutions, rapid, almost 100% conversion would take place. The higher the pH of the solution, the slower the chlorine dioxide formation, and therefore the lower the yield. The fact that the chloride anions have a catalytic effect is advantageous. These are present in sufficient concentration.

The examples show that despite the alkaline pH of the starting components and their non-oxidative effect, and without the addition of a catalytically active component or a catalyst, a significant formation of chlorine dioxide occurs, sufficient for disinfection purposes.

1. Method for the production of chlorine dioxide for disinfection purposes, in which a two-component system in aqueous solution is used, wherein the two-component system is formed from a chlorite component and a salt component, whereby the chlorite component contains an earth alkali chlorite and/or alkali chlorite, and whereby the salt component contains an alkali metal halogenide or earth alkali metal halogenide, or a sulfate or nitrate of alkali metal or earth alkali metal, or a mixture thereof, as the main component, and does not have an acidic nor an oxidative nor a catalytic effect with regard to chlorite, in aqueous solution.

2. Method according to claim 1, wherein the salt component contains a sodium halogenide or potassium halogenide or sulfate or nitrate of sodium or potassium, or a mixture thereof, as the main component.

3. Method according to claim 1, wherein the chlorite component and the salt component are dissolved in water, particularly as a homogeneous binary solid substance mixture or as a shaped product.

4. Method according to claim 1, wherein the chlorite component is added to the solid salt component as a prefinished aqueous solution.

5. Method according to claim 1, wherein a solution of the chlorite component and a solution of the salt component are mixed.

6. Method according to claim 1, wherein the salt component reacts essentially in neutral or alkaline manner in aqueous solution.

7. Method according to claim 1, wherein the salt component consists of sodium chloride.

8. Method according to claim 1, wherein the salt component additionally contains secondary components such as production aids or contaminants, with a proportion of max. 2 wt.-%.

9. Method according to claim 1, wherein a technical regeneration salt for ion exchangers, for example according to the EN 973 standard, is used as the salt component.

10. Method according to claim 1, wherein the chlorite component consists of sodium chlorite, preferably with a total content of less than 3 wt.-%.

11. Preparation for the production of chlorine dioxide in aqueous solution for disinfection purposes, containing an earth alkali chlorite and/or alkali chlorite as the chlorite component, and an alkali metal halogenide or earth alkali metal halogenide, or a sulfate or nitrate of alkali metal or earth alkali metal, or a mixture thereof, as the salt component of a two-component system, whereby the salt component does not have an acidic nor an oxidative nor a catalytic effect with regard to chlorite, in aqueous solution.

12. Preparation according to claim 11 as a shaped product, particularly as a mantled or layered tablet.

13. Preparation according to claim 11 as a preferably homogeneous binary solid substance mixture.

14. Preparation according to claim 11, wherein the salt component consists of sodium chloride.

15. Preparation according to claim 11, wherein the salt component additionally contains secondary components such as production aids or contaminants, with a proportion of max. 2 wt.-%.

16. Preparation according to claim 11, wherein salt component is formed by technical regeneration salt, for example according to the EN 973 standard.

17. Preparation according to claim 11, wherein the chlorite component consists of sodium chlorite.

18. Use of a method or preparation according to claim 1 in ion exchangers, particularly in water treatment or household appliances, particularly dishwashers.

19. Use of a method or preparation according to claim 1 in formulations of foods or cosmetics.
